(19) United States
(12) Patent Application Publication
(10) Pub. No.: US 2011/0099769 A1
(43) Pub. Date: May 5, 2011

(54) ANCHOR FOR EMERGENCY EVACUATION LINES FOR BUILDINGS

(76) Inventors: Roberto Barambio Donate, Villalba de la Sierra (ES); Pablo Munoz-Del Olmo, Villalba de la Sierra (ES); Martin Norbert Birtel, Villalba de la Sierra (ES); Carlos Alarcón Pedroche, Villalba de la Sierra (ES)

(21) Appl. No.: 12/736,671

(22) PCT Filed: Apr. 28, 2008
(86) PCT No.: PCT/ES2008/000290

§ 371 Date: Jan. 6, 2011

(51) Int. Cl. A62B 1/04

(52) U.S. Cl. 24/132 R

(57) ABSTRACT

The invention is especially designed for evacuation lines or ropes for buildings, such as those which are temporarily set out, for example, when fire blocks the normal exits of the buildings, such as lifts, staircases and the like. The invention consists of an elongated arm to be inserted between the door and the door frame, and to which a rocker is connected in an articulated manner, in the central part of the arm, the rocker having, in turn, in its central part, a rut or groove having a V-shaped cross-section for receiving the upper end of the rope, and a pair of end sections parallel to the end sections of the arm. One of said end sections forms, with the corresponding section of the arm, pliers or vise for fixing to the door, and for permanently keeping the door closed by means of a spring, while the other end section of the rocker forms, together with the corresponding end section of the arm, a grip for opening the pliers.

### INVENTION OBJECTIVE

The present invention refers to an anchor that has been specially designed for building evacuation lines or ropes, as those used in the case of an emergency; for example, when a fire blocks the regular building exits; such as elevators, stairs and the like.

The objective of the invention is to provide a fast, practically instant, easy and secure fixed support to any door in any building in the case of a emergency; a support that can be fixed to any door anywhere in the building and then serves to securely attach an evacuation rope or line to rescue people from the building

The anchor is specially suited to be used as an added component in firefighting equipment, but can obviously also be used as a personal preventive measure.

### INVENTION BACKGROUND

In certain cases of emergency, as when a building is on fire, it is common for the regular exits to be affected or blocked by the fire, making it necessary to resort to the less usual evacuation lines; as for example, having to evacuate by sliding down a rope on the outer side of a building or down any other appropriate vertical structure of the same.

Logically the rope must be firmly secured to an appropriate support, as for example, to a pillar, a railing, etc. . . . , but in many cases it's a challenge to find a secure place to anchor the rope and the need to use alternative items arises, as for example, to furniture legs, door knobs or handles, etc. . . . , many times those improvised anchors don't have the resistance needed to hold the weight of the person or people that will use the rope to descend.

To obviate the problem, ROBERTO BARAMBIO DONATE, one of the petitioning parties, is claimant of utility model 200600020 of an building evacuation line anchor consisting of a U shaped metal semi-clasp, with its lateral sides extending perceptively wider than the size of any conventional door found in any building; a semi-clasp that has on one of its lateral sides a threaded orifice in which there is a moving pressure pad interiorly finished in a stud and on the exterior has a bracket or the like, in a way that through the stud the anchor is securely fixed to the edge of a door and that from it the evacuation line or rope can be suspended conveniently tied to a ring that is firmly attached to the mentioned semi-clasp.

Although the solution seems fully efficient from a secure door anchor point of view, in reality there is a consistent handling issue that causes the pressure pad tightening maneuver to be slow, taking up precious seconds when a situation such as a fire pressures time; an operative slowness that can often accentuate a person's nervousness under an extreme situation.

### INVENTION DESCRIPTION

The anchor proposed by the invention, having similar features to the previously mentioned in regards to safety and efficiency, has been created and structured in order to achieve an extremely fast assembly, almost instant, regardless of the thickness of the door or any other factors.

To do so and being more specific, the anchor is structured with a relatively elongated arm, in which there are two wing like levels opposite each other, one to simultaneously lean on one of the sides and one of the edges of the door, and the other in a similar manner on the door frame when the door comes close to closing.

The mentioned arm, due to its central area, is attached in an articulate manner to a rocker creating with it a type of pliers with the rocker having in its central area a depression or groove with a V-shaped cross-section, with the purpose of supporting the rope, with one of the rocker's ends on the opposite side of the door, to which the entire anchor is fixed and secured through a clamp that's the result of a spring mounted on the seesawing axle of both parts and that tends to the closing of the mentioned clasp, while its other end or extreme, at the same time facing the part of the arm that is destined to face the frame, acts with the later creating the manual tightening portion for the opening and release of the vise imposed on the door.

### DRAWING DESCRIPTIONS

To complement the description and in order to help better understand the invention's characteristics, according to a preferred practical realization sample of the same, enclosed as an integral part of the description is a set of drawings of an illustrative but not limited character, representing the following:

FIG. 1.—Shows an exploded view of a building emergency evacuation line anchor with realized according to the objective of the present invention.

FIG. 2.—Shows a ground view of the previous illustration, properly assembled and in an operating position on a door.

### PREFERRED EMBODIMENTS OF THE INVENTION

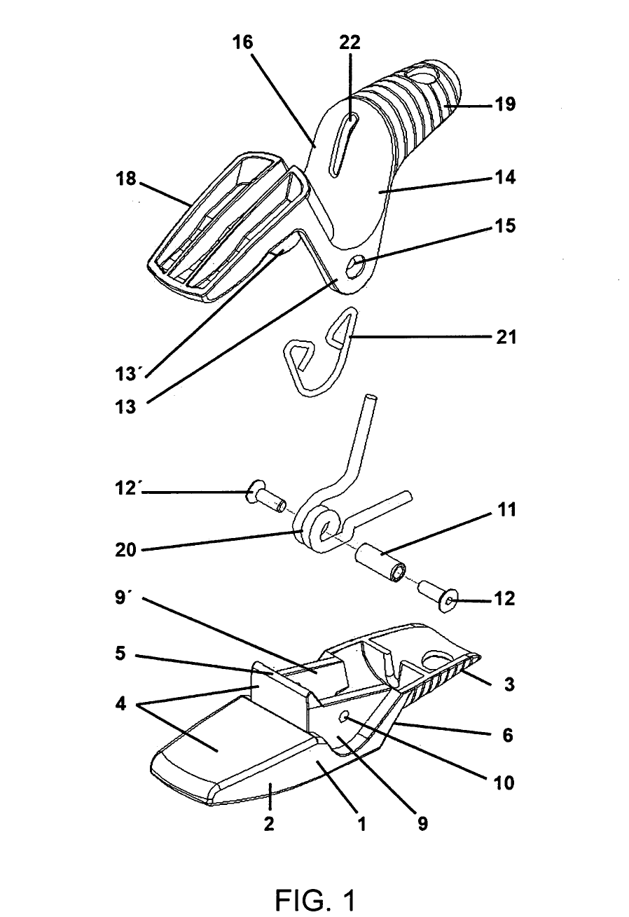

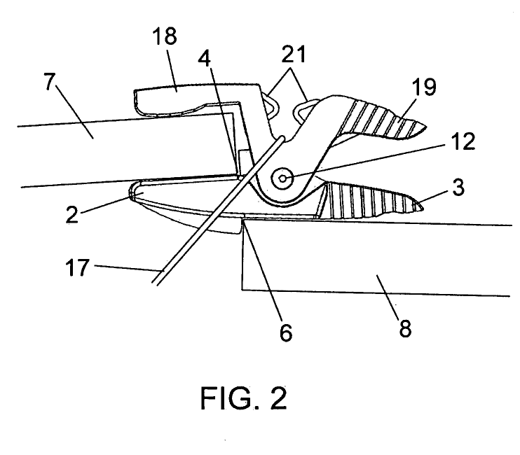

In regards to the reviewed illustrations and in particular to FIG. 1; it can be seen how the proposed anchor is composed of a relatively elongated arm (1), made of any material that offers the adequate resistance, in which two extreme portions are defined (2) and (3), forming one of the extremes (2) a straight dihedral angle (4) by means of a lateral prolongation (5) united as one piece to the arm, while the other extreme (3) at the same time defining another dihedral angle (6) opposite to the latter, with both dihedral angles (4) and (6) having the purpose of receiving the door (7) and the door frame (8); frame that on FIG. 2 is represented schematically next to the complementary frame and partition.

In the midsection of the body (1) are a pair of plates (9-9), that are perceptibly recessed and have respective coaxial orifices (10) to allow the passing of a seesawing axle, in the figure, through a threaded cap (11) on which two opposing screws are screwed on (12-12), the axle affecting simultaneously the other two plates (13-13) that are part of a rocker (14), complementing the arm (1), the plates also having orifices (15) to allow the passing of the aforementioned axle (11-12-12). If avoiding the disassembly of the various parts of the device were pretended, the previous solution could be substituted by a rigid axle, for example, by riveting both extremes.

In its center area, the rocker (14) has a deep depression or groove (16), to connect and secure the evacuation line or rope (17), as is illustrated in FIG. 2, that is framed by two extreme sections (18 and 19), in a way that the extreme section (18) is facing the extreme sector (2) of the arm (1) and that constitutes with the latter a type of pliers or vise that permanently tends to the closing by means of a spring (20) places over the seesawing axle cap (11) between both parts, while the other extreme section (19) acts as a grasp conjunctively with the arm's extreme section (3), to open the mentioned pliers or vise.

The described structure complements a spring (21) with both of its ends having access through their respective grooves (22) to the rocker's depression or groove (16), throttling the entrance of the same and acting as a means of retention for the rope (17), it is to say, avoiding the accidental decoupling of the same.

According to the structure and before an emergency situation, the rope (17) can be connected to the anchor, properly said, in an almost instant manner, and the mentioned anchor, as if it were a pliers, is in turn, also almost instantly fixed to the edge of a door (7), having the mentioned pliers effect the sole purpose of securing the anchor to the door, since all the stress of the rope is absorbed by the arm (1) that acts as a wedge between the door and the frame, as is shown in FIG. 2, making the seesawing and decoupling impossible, not only due to its thickness being considerably more than the space define between the door and the frame when the door tends to be in an almost closed position, but also because the dihedral angle (4) configured in the arm itself connects to the dihedral angle created by the door's corresponding front side and border, impeding its movement, and at the same time the opposing dihedral (6) angle impedes the sliding of the anchor on the interior side of the frame.

As previously mentioned, being able to secure the anchor to the door in an easy and fast manner, can be decisive when a situation, such as a building on fire, pressures time.

1. Building emergency evacuation line anchors, the types
destined to be secured to any door in a building, which at the same time create the means to secure the upper end of a descending line or rope; characterized by an elongated arm, destined to be placed between a door and its frame, the arm articulately attached in its center area to a rocker, which, also in its center area, has a depression or groove with a “V” cross section with the purpose of receiving the upper end of the rope; and a pair of extreme sections that are parallel to the arm's extremes', constituting one of the extreme sections, conjunctively with the one corresponding the arm, with locking pliers or vise that lock on the door, and that permanently tend to the closing by means of a spring, while the rocker's other extreme sector creates, conjunctively with the arm's corresponding extreme sector, a grasp to open the mentioned pliers or vise.

2. Building emergency evacuation line anchors, according to the 1^{st} claim, characterized by the mentioned arm that incorporates two opposite dihedral angle wing like levels, one adapted to the front side and edge of the door, and the other adapted to the back side and corresponding edge of the frame, in a way that the dihedral angles impede the arm's longitudinal movement and seesawing in respect to the door.

3. Building emergency evacuation line anchors, according to claim 1, characterized by the arm that incorporates in its center a pair of plates coaxial orifices, which has other plates with the rocker's coaxial orifices, simultaneously passing through from one orifice to another on the rocker's seesawing axle, which creates the support the spring that tends to the closing of the mentioned clasp.

4. Building emergency evacuation line anchors, according to claim 1, characterized by the V-shaped cross-section depressions or grooves in the rocker's center area, which has incorporated on both lateral extremes grooved areas that face each other and which lodge the extreme of a strap that throttles the entrance of the aforementioned depression.
